(19) United States
(12) Patent Application Publication
(10) Pub. No.: US 2014/0135420 A1
(43) Pub. Date: May 15, 2014

(54) Ready-Mix Joint Compounds Using Non-Uniformly Substituted Carboxylmethylcellulose

(71) Applicant: Hercules Incorporated, Wilmington, DE (US)

(72) Inventor: Thomas J. Podlas, Hockessin, DE (US)

(73) Assignee: Hercules Incorporated, Wilmington, DE (US)

(21) Appl. No.: 14/074,199

(22) Filed: Nov. 7, 2013

Related U.S. Application Data
(60) Provisional application No. 61/724,328, filed on Nov. 9, 2012.

(51) Int. Cl. C04B 24/26

(52) U.S. Cl. CPC C04B 24/2623; C04B 24/26
USPC 523/122

(57) ABSTRACT

The presently disclosed and claimed inventive concept(s) relates generally to a carboxymethylcellulose (CMC) system for use in ready-mix joint compounds. More specifically, the presently disclosed and claimed inventive concept(s) relates to a non-uniformly substituted (“blocky”) CMC system for use as an efficient thickener and rheology modifier for ready-mix joint compounds and the use of a reduced amount of clay for improving the joint compounds.

### CROSS REFERENCE TO RELATED APPLICATIONS

The present application claims the benefit under 35 U.S.C. 119 (e) of U.S. Provisional Patent Application Ser. No. 61/724,328, filed Nov. 9, 2012, the entire content of which is hereby expressly incorporated herein by reference.

### BACKGROUND OF THE INVENTION

1. Field of the Presently Disclosed and Claimed Inventive Concept(s)

The presently disclosed and claimed inventive concept(s) relates generally to a carboxymethylcellulose (CMC) system for use in ready-mix joint compounds. More specifically, the presently disclosed and claimed inventive concept(s) relates to a non-uniformly substituted (“blocky”) CMC system for use as an efficient thickener and rheology modifier for ready-mix joint compounds and the use of a reduced amount of clay for improving the joint compounds.

2. Background and Applicable Aspects of the Presently Disclosed and Claimed Inventive Concept(s)

Wallboard is generally installed in large panels, which are nailed, screwed, or glued to the studding of walls of buildings. The joints where sections of the wallboard are butted together are covered with a joint compound and then a fiberglass or paper reinforcing tape is embedded within the joint compound and then permitted to dry. When the joint compound is dry, a second application of the joint compound is applied over the joint and is permitted to dry. A coating of the joint compound is also applied to cover nail heads or screws or any cracks in the wallboard and let dry. After the joint compound dries, the joint and covering of the nails or screws are lightly sanded and the wall is then finished with decorating material such as paint.

Typically, a joint compound contains a binder, a thickener system, filler, water, a biocide, clay and mica. This joint compound is a ready-mix, drying type composition. The water and filler are the ingredients that comprise the largest weight percentage in the joint compound. Joint compounds can be either regular weight compounds that are the traditional type or lightweight compounds. The regular weight joint compounds have a weight of about 12 to about 15 pounds per gallon (ppg) (1.55-1.65 g/cc) while the lightweight joint compounds have a weight of about 7 to about 11 ppg (0.9-1.2 g/cc).

Non-ionic cellulose ethers are typical and historic thickeners for joint compounds. These cellulose ethers include, among others, water-soluble methylhydroxypropylcelluloses (MHPC), methylhydroxyethylcelluloses (MHEC), hydrophobically modified hydroxyethylcelluloses (HMHEC), hydroxyethylcelluloses (HEC) and ethylhydroxyethylcelluloses (EHEC), and blends thereof.

Cellulose ethers used in a joint compound can function to increase the viscosity of the joint compound, to provide sufficient water retention, and to allow the troweled joint compound to wet the wallboard and tape substrates at a controlled rate so that penetration of the compound into the substrates occurs. Upon drying, a strong adhesive bond between the joint compound, wallboard and paper tape is then achieved. The cellulose ether also controls the joint compound rheological properties, making it easier for a craftsman to apply and trowel the compound to form a smooth, homogeneous surface on the substrate.

Carboxymethylcellulose (CMC) can be an improvement over the above thickeners. The other cellulose ethers entrain air, especially the methylcelluloses. This often leads to pocking (cratering) and cracking, necessitating re-working the coating. Hydroxyethylcelluloses also entrap air, causing similar problems. However, because of its ionic character and high surface/interfacial tension, CMC does not cause air entrainment or entrapment and is known to be an excellent adhesive. In addition, CMC provides smooth rheology, and is easily spreadable.

Ready-mix joint compounds typically contain a latex or other binders, ground calcium carbonate, attapulgite or other clays, mica and talc which are sources of cationic species including, e.g. Mg²⁺ and Ca²⁺ which readily interact with and can precipitate CMC. These reactions result in unacceptable joint compounds that are streaky, elastic, and contain small, undispersed, un-hydrated or partially-hydrated CMC-metal cation complexes and possibly other agglomerated solids. This phenomenon may occur initially as the joint compound ingredients are being mixed together or with time after the joint compound has been packaged. It is for these reasons that CMCs are seldom used as joint compound thickeners.

Under very limited conditions, CMC can be made to function as joint compound thickeners, usually making use of higher concentrations of CMC than are now used with other typical joint compound thickeners. The CMC used are either insoluble or soluble in water. For example, 0.6 wt % or higher soluble CMC can be used. In contrast, typical thickeners in a regular weight joint compound used are in the range of about 0.35-0.4 wt %.

Attapulgite clay is a standard thixotrope in joint compounds, providing the necessary viscosity and thickness without which the joint compound would be difficult if not impossible to spread and remain on the substrate. Attapulgite is primarily found only in North America. Without the attapulgite, the joint compound would have the flow properties of a thick paint. In other words, it would flow when applied at a measurable thickness to wallboard.

Attapulgite, a natural product, has variable compositions that affect joint compound properties. So, the clay must often be tested and standardized on a batch-to-batch basis. For these and other reasons, attempts have been made to find a suitable substitute for the clay with very limited success.

### DETAILED DESCRIPTION

Before explaining at least one embodiment of the inventive concept(s) in detail by way of exemplary drawings, experimentation, results, and laboratory procedures, it is to be understood that the inventive concept(s) is not limited in its application to the details of construction and the arrangement of the components set forth in the following description or illustrated in the drawings, experimentation and/or results. The inventive concept(s) is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Unless otherwise defined herein, scientific and technical terms used in connection with the presently disclosed and claimed inventive concept(s) shall have the meanings that are commonly understood by those of ordinary skill in the art. Further, unless otherwise required by context, singular terms shall include pluralities and plural terms shall include the singular. Generally, nomenclatures utilized in connection with, and techniques of chemistry described herein are those well known and commonly used in the art. Reactions and purification techniques are performed according to manufacturer's specifications or as commonly accomplished in the art or as described herein. The nomenclatures utilized in connection with, and the laboratory procedures and techniques of, analytical chemistry, synthetic organic chemistry, and medicinal and pharmaceutical chemistry described herein are those well known and commonly used in the art. Standard techniques are used for chemical syntheses, chemical analysis, pharmaceutical preparation, formulation, and delivery, and treatment of patients.

All patents, published patent applications, and non-patent publications mentioned in the specification are indicative of the level of skill of those skilled in the art to which this presently disclosed and claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the inventive concept(s) as defined by the appended claims.

As utilized in accordance with the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, and/or the variation that exists among the study subjects. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

Disclosed herein are a ready-mix joint compound and use of a reduced amount of clay for improving the joint compound. Specifically, the ready-mix joint compound comprises a binder, a non-uniformly substituted CMC, a filler, water, a biocide and an attapulgite clay. In addition, the joint compounds thickened with the CMC system of the presently disclosed and claimed inventive concept(s) have very good workability and water retention.

The non-uniformly substituted CMC of the presently disclosed and claimed inventive concept(s) can be used in conjunction with a chelant. Examples of the chelant can include, but are not limited to, citric acid, tartaric acid, gluconic acid, maleic acid, 5-sulfosalicylic acid, ethylenediaminetetraacetic acid, ethylenediamine, diethylenetriamine, triethylenetetramine, triaminotriethylamine, triethanolamine, acetylacetone, salicylaldehyde, polyethyleneimines, and polyphasphates such as hexametaphsphoric acid. While not wishing to be bound by any theory, it is believed that these chelants may function to chelate with the low molecular weight cationic species found in typical joint compounds, preventing the CMC to be precipitated to form CMC-metal ion complexes.

In some instances a source of aluminium or other polyvalent cations can be added to the ready-mix joint compounds. The polyvalent cations can include, but are not limited to, divalent zinc, manganese, the ferrous ion of iron, the cupric ion of copper and trivalent chromium. It is postulated that the Al⁺³ complexes with the CMC carboxyl groups, which results in controlled crosslinking of the polymer to thicken and regulate the rheology of the compound. In one non-limiting embodiment, the aluminium ion can be aluminium sulfate.

During manufacturing joint compounds, the CMC system of the presently disclosed and claimed inventive concept(s) in one non-limiting embodiment, while soluble, may not be dissolved in the time required to blend the ingredients. This swelling property results in an improved efficiency of viscosity build up compared to instantly soluble CMCs. Surprisingly, it has been found that the CMC in the swollen state can act as a thixotrope and allow one to remove portions of the clay and retain necessary rheological properties. It has also been surprisingly found that all of the clay may be removed, depending on specific formulations.

Clay is typically used at about 1.5-2.5 wt % level, based on total weight of joint compound, often higher in lightweight products. The CMCs of the presently disclosed and claimed inventive concept(s) can provide improved performances in latex-based systems, ready-mix joint compounds, especially designed to function when attapulgite clay levels are decreased at least about 50% below typical use levels, preferably about 75% with respect to typical industry-accepted use levels.

For a regular weight joint compound, in one non-limiting embodiment, the attapulgite clay can be present in the amount from about 0 to about 1.25 wt %. In another non-limiting embodiment, the attapulgite clay can be present in the amount from about 0 to about 1.9 wt %. For a light weight joint compound, in one non-limiting embodiment, the attapulgite clay can be present in the amount from about 1.25 to about 1.75 wt %. In another non-limiting embodiment, the attapulgite clay can be present in the amount from about 0.6 to about 0.9 wt %.

In addition, the CMC system of the presently disclosed and claimed inventive concept(s), once incorporated into a filled system such as a ready-mix joint compound, will not dissolve with time, joint compounds remaining stable with aging, for at least about 6 months. Stability of about a year has been realized.

The non-uniformly substituted CMC according to the presently disclosed and claimed inventive concept(s) has a degree of substitution (DS) of at least about 0.35. In one non-limiting embodiment, the DS is in the range of from about 0.35 to about 1.4. In another non-limiting embodiment, the DS is in the range of from about 0.5 to about 0.9. In yet another non-limiting embodiment, the DS is in the range of from about 0.6 to about 0.8. In one non-limiting embodiment, the non-uniformly substituted CMC is AQUALON® CMC-7H4F-M (available from Ashland Inc.).

A blocky CMC differs from other CMCs in that the structure of the blocky CMC is more greatly affected by pH increase. For example, 1% solution of soluble AQUALON® CMC 7H4F-type has a viscosity of 1550 cps (30 rpm, Brookfield viscometer). AQUALON® CMC 7H4F-M of the presently disclosed and claimed inventive concept(s) under the same conditions is 3850 cps and is structured. The structure is diminished when the pH of the AQUALON® CMC 7H4F-M solution is increased. As a result, the AQUALON® CMC 7H4F-M is solubilized and now has a viscosity of 2560 cps when the pH is raised to about 10. The lower viscosity approaching of AQUALON® CMC 7H4F-type can be observed as the pH is further increased. In contrast, CMC solutions generally maintain their normal viscosity over a wide pH range with only a slight decrease in viscosity at pH above 10.

The performance in joint compound of the AQUALON® CMC 7H4F-M and pH adjusted AQUALON® CMC 7H4F-M is quite different, which is shown in Table 1 below. 20 grams of a CMC-containing solution or dispersion were added to 300 grams joint compound having 520 BU viscosities. 300 grams were also diluted with water to demonstrate the effect of the CMC.

TABLE 1
Non-Uniformly Substituted CMC: Induced Changes

| | Joint compound | | |
|---|---|---|---|
| | Brabender | | |
| Added to joint | viscosities | | |
| compound (20 grams) | 10 rpm | 79 rpm | Comments |
| AQUALON ®CMC | 400 | 380 | Joint compound viscosity was decreased |
| 7H4F (more uniformly | | | from 520 BU due to dilution effect. |
| substituted CMC) | | | |
| AQUALON ®CMC | 690 | 670 | Higher than expected BU due to swellable |
| 7H4F-M (less/non- | | | CMC, structured nature of hydrated |
| uniformly substituted | | | polymer chains |
| CMC) | | | |
| AQUALON ®CMC | 470 | 430 | Destruction of polymer chains, solubilizing |
| 7H4F-M | | | the 7H4F-M, gave properties approaching |
| (1% dispersion pH | | | those of CMC 7H4F, soluble polymer. |
| raised to 10) | | | |
| Tap water | 210 | 280 | Dilution of joint compound with H₂O |

The commonly used binders in ready-mix, drying type joint compounds are latex emulsions, for example but not by way of limitation, polyvinyl alcohol, ethylene vinyl acetate tax, or poly(vinyl acetate) latex, which are acidic. The resinous binder is a coalescent agent that upon drying forms a thin matrix that holds the other ingredients in their proper places so as to form the desired product. Hence, the binder is an essential ingredient in the joint compound. Other materials can be used as binders can include, but are not limited to, starch, casein, polyacrylamide, and copolymers of acrylamide and acrylic acid. In general, the latex binder ranges from a lower limit of about 1 wt % to an upper limit of about 3 wt %. In one non-limiting embodiment, the latex binder is about 2.5 wt % based on the total weight of the joint compound.

A biocide is an important ingredient in a joint compound. It can increase the shelf life and prevent the compound from spoiling. In other words, the biocide can prevent microorganisms such as mold, bacteria and fungi, from growing in the compound and also on the walls of the building structure in which it is used. Examples of two efficient industry-accepted biocides can be Mergal® 174, 2[(hydroxymethyl)amino]ethanol, a broad spectrum biocide, manufactured by Troy Chemical Corp; and Proxel™ GXL product, 1,2-benzisothiazolin-3-one, an all purpose biocide, manufactured by Arch Chemicals, Inc.

Other biocides can include, but are not limited to, copper oxine, zinc stearate, calcium borate, zinc borate, barium borate, zinc omadine, zinc omadine/zinc oxide mix, 2,5-dimethyl-1,3,5-thiadiazinane-2-thione (Thione), 2-n-octyl-4-isothiazolin-3-one (octhilinone), 5-chloro-2-methyl-4-isothiazolin-3-one, 2-methyl-4-isothiazolin-3-one, hexahydro-1,3,5-triethyl-2-triazine, 5-bromo-5-nitro-1,3-dioxane, 2-(hydroxymethyl)amino-ethanol, 2-(hydroxymethyl)amino-2-methylpropanol, α-benzoyl-α-chlorofomaldoxime, benzyibromoacetate, p-chloro-m-xylenol, bis-(2-hydroxy-5-chlorophenyl)sulfide, p-tolydiiodomethylsulfone, 3-iodo-2-propynylbutylcarbamate, bis-(2-hydroxy-5-chlorophenyl) methylene, dipropylamine ether, dodecylamine, and 1-(3-chloroallyl)-3,5,7-triaza-1-azoniaadamantane chloride.

The biocide can generally be present in the amount ranging from a lower limit of about 0.05 to an upper limit of about 1% by weight based on the total weight of the compound.

Fillers are also an importance ingredient in a joint compound. They serve the purpose of adding body to the joint compound, making the compound economical, and controlling the pH of the compound. Conventional fillers that can be used either alone or in combination in the presently disclosed and claimed inventive concept(s) can include, but are not limited to, calcium carbonate, calcium sulfate dihydrate (gypsum), and dolomitic limestone. Calcium sulfate hemihydrates (plaster of Paris) can be used as a minor component in the presence of other fillers in order to better control open time and cracking and other joint compound properties.

In one non-limiting embodiment, the filler can be finely ground calcium carbonate. The filler can be a dry powder, which usually comprises at least about 45 wt % based on the weight of the joint compound. In one non-limiting embodiment, the filler is in the range from about 45 to about 65% by weight. The filler can be used to control and achieve the desired pH of the compound of about 8 to about 10. If the filler cannot provide the adequate adjustment of the pH, if necessary, a pH modifier can also be added.

Water can be added to the dry ingredients of the joint compound to provide the viscosity of the joint compound, generally in the range of from about 300 to about 700 Brabender units. When the dry ingredients are mixed on site, the amount of water added to form a ready-mix joint compound or a wetted joint compound will depend on the desired viscosity.

In addition to attapulgite, other clays can also be used in the presently disclosed and claimed inventive concept(s). The suitable clays can be any of the natural earthy, fine-grained, largely crystalline substances of hydrous aluminium silicates usually containing alkalies, alkaline earth, and iron that make up the group of clay materials. Examples of clay can include, but are not limited to, sepiolite, montmorillonite, bentonite, illite, and kaolin.

The ready-mix joint compound can further comprise other non-ionic thickener and/or an anionic thickener. Suitable non-ionic thickener can include, but are not limited to, methylhydroxylethyl cellulose (MHEC), hydroxyethyl cellulose (HEC), hydroxymethyl hydroxyethyl cellulose (HMHEC), and ethylhydroxyethyl cellulose (EHEC), hydrophobically modified hydroxyethylcellulose, hydroxypropyl methylcellulose (HPMC), hydroxypropyl guar, and derivative guar.

The anionic thickener can include other CMC products not covered by this presently disclosed and claimed inventive concept(s). Other suitable anionic thickeners can include, but are not limited to, cross-linked acrylic acid-vinyl ester copolymer; sodium polyacrylate; acrylic acid/VP crosspolymer; acrylates/aminoacrylates/C10-30 alkyl PEG-20 itaconate copolymer; acrylates/steareth-20 itaconate copolymer; acrylates/ceteth-20 itaconate copolymer; dehydroxanthan gum; caprylic/capric triglyceride/sodium acrylates copolymer; sodium polyacrylate/hydrogentated polydecence/PPG-5 laureth-5; polyacrylamide/C13-14/Iaureth-7; polyacrylate 13/polyisobutene/polysorbate 20; acylamide ammonium acrylate copolymer/polyisobutene/polysorbate 20; sodium acrylate/sodium acryloyldimethyl taurate copolymer/polyisobutene/capryl)-capryl glucoside; sodium acrylate/sodium acryloyldimethyl taurate copolymedisohexadecane/polysorbate 80; hydroxyethyl acrylate/sodium acryloyldimethyl taurate copolymer/squalane/polysorbate 60; hydroxyethyl acrylate/sodium acryloyldimethyl taurate copolymer/isohexadecane/polysorbate 60; caprylic/capric triglyceride/ammonium acryloyldimethyltaurate/beheneth-25 methacrylate cross polymer; ammonium acryloyldimethyl-taurateNP copolymer; caprylic/capric triglyceride/ammonium acrylolydimethyltaurate/beheneth-25 methacrylate crosspolymer; ammonium acryloyldimethyltaurate/beheneth-25 methacrylate crosspolymer; caprylic/capric triglyceride/ammonium acryloyldimethyltaurate/VP copolymer/trilaureth-4 phosphate/polyglyceryl-2 sesquiisostearate; sodium polyacrylate/C13-14 isoparaffin/trideceth-6; sodium polyacrylate/hydrogenated polydecence/trideceth-6; and hydrophobically-modified alkali soluble polymer emulsion.

Depending on local preferences, other ingredients can be used in the joint compound. These ingredients can include, but are not limited to, air entraining agents, surfactants, humectants, pH buffering salts, defoamers, and mixtures thereof.

In one non-limiting embodiment, a regular weight joint compound can include about 0.35-0.45 wt % CMC, about 3.1-6.2 wt % citric acid (based on CMC), and optionally, about 3-wt5% aluminium ion (based on CMC). Here, aluminium ion is normally used in the presence of VAE lax. In another non-limiting embodiment, a regular weight joint compound may include about 0.4 wt % CMC, about 5 wt % citric acid (based on CMC), and optionally about 4 wt % aluminium ion.

In one non-limiting embodiment, a light weight joint compound can include about 0.4-0.55 wt % CMC, about 3-7 wt % citric acid (based on CMC), and about 3-7 wt % aluminium ion (based on CMC). The amount of CMC depends on the type and amount of perlite. In another non-limiting embodiment, a light weight joint compound may include about 0.45 wt % CMC, about 5-6 wt % citric acid (based on CMC), and optionally about 5-6 wt % aluminium ion.

Citric acid can be citric acid monohydrate and its particle size can be matched to that of the thickener. The aluminium ion can be aluminium sulphate hexadecahydrate. In one non-limiting embodiment, the aluminium sulphate hexadecahydrate powder can be used.

Citric acid and aluminium ion may be mixed with other dry components. They can also be pre-dissolved in water prior to adding to other components. If particle size differences and other formulation variables negatively affect its performance, the above recommendations may be varied. If plant conditions allow, pre-testing can be carried out.

Industry-accepted techniques for preparing joint compounds in the laboratory can be used in the presently disclosed and claimed inventive concept(s). For example but not by way of limitation, all liquids can be put in a bowl equipped with a Hobart mixer. Solid ingredients can be dry-blended (layered, not intimately mixed), added to the liquids over about 30 seconds while the Hobart mixer is at low speed. Total mixing time can be about 20 minutes, with interruptions after about 2 and about 5 minutes to scrape down all materials to affect more efficient mixing. Compounds are put in containers, evaluated in about 24 hours.

The following examples illustrate the presently disclosed and claimed inventive concept(s), parts and percentages being by weight, unless otherwise indicated. Each example is provided by way of explanation of the presently disclosed and claimed inventive concept(s), not limitation of the presently disclosed and claimed inventive concept(s). In fact, it will be apparent to those skilled in the art that various modifications and variations can be made in the presently disclosed and claimed inventive concept(s) without departing from the scope or spirit of the invention. For instance, features illustrated or described as part of one embodiment, can be used on another embodiment to yield a still further embodiment. Thus, it is intended that the presently disclosed and claimed inventive concept(s) covers such modifications and variations as come within the scope of the appended claims and their equivalents.

### EXAMPLES

### Enzymatic Hydrolysis

Unsubstituted anhydroglucose (UAG) units released after a specific enzymatic hydrolysis can be obtained with the commercial endoglucanase enzyme. Further explanation of substituted cellulose blockness and measurement can be found in detail in Virden et al., Biomacromolecules, 2009, 10, pp 522-529, the entirety of which is incorporated herein by reference.

Enzymatic hydrolysis was performed on the phosphate buffer at pH 6.0 (0.1 M). The sample was weighed (500 mg) in accurate 1 mg. The sample was dissolved in 50 ml phosphate buffer until completely dissolved. endo-β-glucanase (EC 3.2.2.4) (from Bacillus. Amyloliquifaciens, available from Megazyme, Bray, Ireland) 35U were added to the sample solution. The hydrolysis was carried out in a shaker at 40° C. for 24 hours. Released unsubstituted anhydroglucose was detected with a high performance anion exchange chromatography with pulsed amperometric detection (HPAEC-PAD) from Dionex (Sunnyvale, Calif.).

UAG by enzymatic hydrolysis is an indication of the uniformity of carboxymethyl substitution on the backbone cellulose polymer. A higher UAG number normally corresponds to a less uniformly substituted or blocky CMC whereas a lower UAG unit corresponds to a more uniformly substituted CMC.

Table 2 lists the values of unsubstituted anhydroglucose by enzymatic analysis for various CMCs

TABLE 2
Unsubstituted Anhydroglucose by Enzymatic Hydrolysis

| Sample | UAG by Enzymatic Hydrolysis. Wt % |
|---|---|
| CMC 7H4 F | 1.15 |
| CMC 7H4 XF | 1.33 |
| CMC 7H4 FM | 1.45 |

### Determination of Joint Compound Viscosity

Viscosity was measured in Brabender units (B.U.) determined by ASTM C474-67. The Brabender VC-3A model viscometer was used. 79 rpm is industry standard. 10 rpm viscosity was used as measuring sag resistance or yield point. Measurements were conducted for about 24 hours after preparation, before and after mixing.

### Raw Materials

Attapulgite clay: Gel B

### Mica: 4K

PVA latex: CPS104, Forbo
VAE latex: A526BP, Air Products

### Perlite: SilCell 3534, Silbrico

### Regular Weight Joint Compound Properties

Table 3 below illustrates the effectiveness of AQUALON® CMC 7H4F-M as a joint compound thickener/stabilizer. Viscosity, adhesion, texture and smoothness are the variables given most attention. It was found that other joint compound properties with CMC are at least equal to those obtained with the MHEC and other conventional thickeners for joint compounds. These properties are crack and pock resistance, shrinkage, workability, stability with aging, and open (working) time.

The following ingredients were common to all joint compounds referenced in Table 3, unless noted otherwise:

### H₂O: 30.5 wt %

Attapulgite clay: 0.5 wt %

### Latex: 2.0 wt % PVA

### Thickener: 0.4 wt %

Joint compounds were prepared, packaged and evaluated in 24 hrs. 600-800 g. quantities were tested, stirred by hand prior to being evaluated.

TABLE 3
Properties of Regular Weight Joint Compounds

| | | | 79 rpm | | |
|---|---|---|---|---|---|
| | | | B U | Adhesion | |
| Example # | Thickener | Additive | Viscosity | (wt %) | Comments |
| 1 | Culminal ® MHEC | — | 490 | 100 | CONTROL: Smooth and |
| | 35000 P1R | | | | creamy texture |
| 2 | AQUALON ® | — | 460 | 99 | Some small, dry lumps |
| | CMC 7H4F-M | | | | |
| 3 | AQUALON ® | 5 wt % | 450 | 100 | Smooth and creamy |
| | CMC 7H4F-M | Citric acid | | | texture, no lumps |
| 4 | AQUALON ® | 5 wt % | 450 | 99 | Trace of lumps |
| | CMC 7H4F-M | Sodium | | | |
| | | citrate | | | |
| 5 | AQUALON ® | 5 wt % | 480 | 95 | Smooth and creamy |
| | CMC 7H4F-M | Maleic acid | | | texture, no lumps |
| 6 | AQUALON ® | 3 wt % citric | 450 | 99 | A few un-dispersed balls |
| | CMC 7H4F-M | acid | | | of CMC with mineral |
| 7 | AQUALON ® | 3 wt % citric | 460 | 97 | Smooth and creamy |
| | CMC 7H4F-M | acid* | | | texture, no lumps |
| 8 | AQUALON ® | 5 wt % citric | 440 | 95 | No lumps |
| | CMC 7H4F-M | acid** | | | |
| 9 | AQUALON ® | —** | 420 | 99 | Body as above; small but |
| | CMC 7H4F-M | | | | finite number of un- |
| | | | | | dispersed particles, small |
| | | | | | lumps |
| 10 | AQUALON ® | 5 wt % citric | 400 | 90 | Elastic rheology, some |
| | CMC 7H4F | acid | | | small lumps |
| 11 | AQUALON ® | 5 wt % citric | 460 | 100 | Smooth & creamy texture. |
| | CMC 7H4F-M + | acid | | | Illustration of blend of |
| | MHEC | | | | CMC with another CE |
| | 35000P1R*** | | | | |

*also contains 0.016 wt % aluminium sulphate hexadecahydrate, 1.3 times that of citric acid
**0 wt % attapulgite clay
***50:50 blend

Example 1 was a control, in which a joint compound contained about 2 wt % attapulgite clay and was thickened with Culminal® MHEC 35000P1R, a product from Ashland.

Examples 2 & 3 illustrate the use of the CMC in emulating the MHEC without and with citric acid.

Example 4 shows the use of sodium citrate instead of citric acid.

Example 5 shows that maleic acid was used.

Example 6 illustrates the use of 3 wt % citric acid based on the CMC content.

Example 7 shows the inclusion of aluminium sulphate hexadecahydrate in the formulation with about 3 wt % citric acid. Unlike Example 6, it provided the necessary smoothness and did not form lumps.

Examples 8 & 9 were clay-free joint compounds thickened with the CMC. With 5 wt % citric acid, no lumps were observed (Example 8). When the acid was not included, lumps were formed, showing that it is not solely the clay that is responsible for lump formation, that the mica, even the CaCO₃ may also be responsible.

Example 10 used a standard, instantly soluble grade of AQUALON® CMC 7H4F. Without the swelling property like that of AQUALON® CMC 7H4F-M, this results in a joint compound with inadequate viscosity and an undesirable elastic rheology.

Example 11 illustrates the ability to blend the CMC with another thickener, in the present case the MHEC used in Ex 1. This is important because different raw materials impart different properties to joint compounds, and the ability to modify these properties by varying the thickener is of utmost importance.

### Lightweight Joint Compound Properties

The following ingredients were common to all joint compounds referenced in Table 4, unless noted otherwise:

### H₂O: 40.6 wt %

### Latex: 2 wt %, PVA or VAE

Attapulgite clay: 0.8 wt %

### Perlite: 6.0 wt %

### Thickener: 0.4 wt %

TABLE 4
Properties of Lightweight Joint Compounds

| | | | | Brabender | | |
|---|---|---|---|---|---|---|
| | | | | 79 rpm | Adhesion | |
| Example # | Thickener | Additive | Latex | [BU] | (%) | Comments |
| 1 | Nexton ® | — | PVA | 320 | 70 | Smooth and creamy |
| | J20R | | | | | |
| 2 | AQUALON ® | — | PVA | 285 | 89 | Smooth; pasty not |
| | CMC | | | | | creamy. Some small |
| | 7H4F-M | | | | | lumps. |
| 3 | AQUALON ® | 5% citric | PVA | 300 | 75 | As above except no |
| | CMC | acid | | | | obvious lumps; troweling |
| | 7H4F-M | | | | | carefully shows the |
| 4 | AQUALON ® | — | VAE | 340 | 82 | As #2 except thicker feel |
| | CMC | | | | | |
| 5 | AQUALON ® | 5% citric | VAE | 290 | 85 | As # 3 |
| | CMC | acid | | | | |
| 6 | AQUALON ® | 5% citric | VAE | 270 | 60 | Smooth and almost |
| | CMC | acid* | | | | creamy. No lumps. |

*also contains 0.067 wt % aluminium sulphatehexadecahydrate, 2.5 times that of citric acid

Example 1 was a control containing about 3 wt % of attapulgite clay and using Nexton® J20R, a HMHEC product from Ashland.

Examples 2 & 3 show that AQUALON® CMC 7H4F-M gave a joint compound with significantly reduced lumping if citric acid was included (Ex 3); without the acid, more and, larger lumps were formed.

Examples 4 & 5 were made with VAE copolymer latex, which typically gives higher viscosity and a thicker feel to joint compounds as opposed to PVA latex. In the absence of citric acid (Ex 4), this thicker feel and higher viscosity were noted. With citric acid (Ex 5) there was no difference compared with Ex 3.

Example 6 shows the positive effect of aluminium ion. No lumps were found and the texture was improved.

It must be realized that the joint compound formulation can affect performance of the chelant and aluminium ion. Exs 2 & 4 had lumps that were evident upon troweling, while Exs 3 & 5 at first glance appeared to be lump-free. Formulation changes, e.g., using different particle size perlite, or perlite that is not surface treated, can affect the results, either in a positive or negative way.

What is claimed is:

1. A ready-mix joint compound comprising a binder, a non-uniformly substituted CMC, a filler, water, a biocide and an attapulgite clay.

2. The ready-mix joint compound of claim 1, wherein the density of the joint compound is about 7 to about 11 pounds per gallon (ppg).

3. The ready-mix joint compound of claim 1, wherein the density of the joint compound is about 12 to about 15 pounds per gallon (ppg).

4. The ready-mix joint compound of claim 3, wherein the attapulgite clay is present in the amount from about 0 to about 1.25 wt %.

5. The ready-mix joint compound of claim 3, wherein the attapulgite clay is present in the amount from about 0 to about 1.9 wt %.

6. The ready-mix joint compound of claim 2, wherein the attapulgite clay is present in the amount from about 1.25 to about 1.75 wt %.

7. The ready-mix joint compound of claim 2, wherein the attapulgite clay is present in the amount from about 0.6 to about 2.0 wt %.

8. The ready-mix joint compound of claim 1, further comprising a non-ionic thickener.

9. The ready-mix joint compound of claim 8, wherein the non-ionic thickener is selected from the group consisting of methylhydroxylethyl cellulose (MHEC), hydroxyethyl cellulose (HEC), hydroxymethyl hydroxyethyl cellulose (HMHEC), and ethylhydroxyethyl cellulose (EHEC), hydrophobically modified hydroxyethylcellulose, hydroxypropyl methylcellulose (HPMC), hydroxypropyl guar and derivative guar, and combinations thereof.

10. The ready-mix joint compound of claim 1, further comprising an anionic thickener.

11. The ready-mix joint compound of claim 1, further comprising a citric acid.

12. The ready-mix joint compound of claim 1, further comprising a chelating acid or a chelating acid salt.

13. The ready-mix joint compound of claim 1, further comprising a chelating agent.

14. The ready-mix joint compound of claim 1, further comprising an aluminium ion.

15. The ready-mix joint compound of claim 11, further comprising an aluminium ion.

16. The ready-mix joint compound of claim 1, further comprising a polyvalent cation.

17. The ready mix joint compound of claim 11, further comprising a polyvalent cation.

18. The ready-mix joint compound of claim 1, wherein the binder is selected from the group consisting of polyvinyl alcohol, ethylene vinyl acetate latex, poly(vinyl acetate) latex, starch, casein, polyacrylamide, and copolymers of acrylamide and acrylic acid.

19. The ready-mix joint compound of claim 1, wherein the filler is selected from the group consisting of calcium carbonate, calcium sulphate dehydrate, dolomitic limestone, and combinations thereof.

20. The ready-mix joint compound of claim 1, wherein the biocide is selected form the group consisting of 2[(hydroxymethyl)amino]ethanol and 1,2-benzisothiazolin-3-one.
